(19) United States
(12) Patent Application Publication
(10) Pub. No.: US 2007/0013234 A1
(43) Pub. Date: Jan. 18, 2007

(54) POWER SWITCH CIRCUIT

(75) Inventor: Yuan-Ko TING, Chung Ho City, Taipei (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: AmTRAN TECHNOLOGY CO., LTD, Chung Ho City (TW)

(21) Appl. No.: 11/381,505

(22) Filed: May 3, 2006

(30) Foreign Application Priority Data
May 6, 2005 (TW) 94114747

(51) Int. Cl. B23K 11/24

(52) U.S. Cl. 307/112

(57) ABSTRACT

A switch circuit is provided for an electric device with a power module. The circuit includes a first signal generating circuit and a second signal generating circuit. The first signal generating circuit issues a first signal, while the second signal generating circuit, connected to the first signal generating circuit, issues a second signal after receiving the first signal. The second signal controls the operation of the power module. Thus the electric device is operable, between being in standby mode and operation mode, through the first signal and the second signal. The switch circuit enables the power module to consume little electric power when the electric device is in standby mode. Only power for the operation of the second signal generating circuit is necessary. Therefore, the power consumption of the electric device in standby mode is greatly reduced.

This application claims the benefit of Taiwan Patent Application No. 94114747, filed on May 6, 2005, which is hereby incorporated by reference for all purposes as if fully set forth herein.

### BACKGROUND OF THE INVENTION

1. Field of Invention

The invention relates to a power switch circuit and, more particularly, to a power switch circuit capable of reducing power consumption during a standby mode of an electrical device.

2. Related Art

The European Community has launched new energy regulations since Jan. in 2001. The power consumption of the power supply is restricted to be a predetermined value during standby mode under the more and stricter regulations. Besides, all the federal government departments are forced to purchase electrical/electronic products whose power consumption is lower than 1W during the standby mode.

The traditional power switch circuit uses mechanic switches to turn on or off electrical devices, and maintain system IC′ operation to control the peripheral circuits during the standby mode of the system. During the standby mode, basic power for maintaining the operation of the system IC is necessary. The internal system still operates, even though the electrical devices are turned off externally. The operating internal system enables the system to return back to operation mode in response to a control signal. However, the power consumption during the standby mode of the system can not be reduced.

R.O.C. patent No. 387584 discloses a power switch system for a computer. The power switch system includes a power source detecting circuit for generating a first signal and a power control circuit connected to the power source detecting circuit for detecting a second signal and for generate a third signal. In response to the first signal, a power supply operates at operation mode and generates the third signal. In response to the second signal, the third signal is changed and the power supply turns to the standby mode. According, page 5, illustrating FIG. 1, the power switch circuit is powered by a battery. The power supply connected to the circuit provides a standby power to the system chipset. Although the system is at standby mode, the power supply still provides power to the system which means power consumption in standby mode still exists. The power switch circuit solves the on/off problem caused when the computer system retains power after the electric power stops. The circuit does not teach or imply any solutions to reduce the power consumption during the standby mode.

To reduce power consumption, triggering during standby mode is employed to conform to the International Energy Association (IEA) regulations. The available power consumption of the switch mode power supply (SMPS) during the standby mode is regulated in the standard which indicates that the power consumption should be reduced to be lower than 1 W. However, it is not easy for current electrical devices to conform to the strict requirement of ‘lower than 1 W power consumption during the standby mode’. Thus, to reduce the power consumption during standby mode to conform to the strict requirements is a high priority.

### SUMMARY OF THE INVENTION

In consideration of the abovementioned problems, the invention is to provide a power switch circuit that effectively reduces the power consumption during the standby mode of the electrical devices.

According to one embodiment of the invention, a power circuit including a first signal generating circuit and a second signal generating circuit is provided. The first signal generating circuit outputs a first signal. The second signal generating circuit, connected to the first signal generating circuit, outputs a second signal after receiving the first signal, which the second signal controlls a power module to stop or start operation.

According to one embodiment of the invention, a power circuit including a first signal generating circuit, a second signal generating circuit, and a driving circuit is provided. The first signal generating circuit outputs a first signal. The second signal generating circuit, connected to the first signal generating circuit, outputs a second signal after receiving the first signal. The second signal is of a high level voltage or low level voltage. The driving circuit outputs a driving signal to drive a power module to stop or start operation in response to the second signal.

According to one embodiment, the invention has a power switch circuit for an electrical device, including a direct current power source, a signal generating circuit, a control circuit, and a driving circuit. The signal generating circuit outputs a trigger signal. The control circuit, connected to the signal generating circuit and powered by the direct current power source, outputs a high level or low level voltage after receiving the trigger signal. The driving circuit, connected to the control circuit, outputs a driving signal to drive a power module to stop or start -operation after receiving the high level or low level voltage.

According to the embodiments of the invention, the provided power switch circuit may control a power module to start or stop operation so that the standby mode and the operation mode of an electrical device may be switched. Moreover, through the provided switch circuit, the system IC is no longer responsible to switch the standby mode and the operation mode of the electrical device. That is to say, the system IC may totally shut down during the standby mode and the power module does not have to supply power to the system, such, that the whole system totally stops operation. The power is merely consumed during the standby mode. Further, when the electrical device is switched to the operation mode from the standby mode, the power module may supply power to the system again.

Further scope of applicability of the invention will become apparent from the detailed description given herein after. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The above and other objects, features and other advantages of the invention will be more clearly understood from the following detailed description when taken in conjunction with the accompanying drawings, in which:

FIG. 1A and FIG. 1B show the block diagram according to the power switch circuit of the invention.

FIG. 2 illustrates the detailed circuitry of the first embodiment of the power switch circuit of the invention.

FIG. 3 illustrates the detailed circuitry of the second embodiment of the power switch circuit of the invention.

FIG. 4A illustrates the detailed circuitry of the third embodiment of the power switch circuit of the invention.

FIG. 4B illustrates the detailed circuitry of the fourth embodiment of the power switch circuit of the invention.

### DETAILED DESCRIPTION OF THE INVENTION

Reference will now be made in greater detail to a preferred embodiment of the invention, of which an example is illustrated in the accompanying drawings. Wherever possible, the same reference numerals are used throughout the drawings and the description to refer to the same or similar parts. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

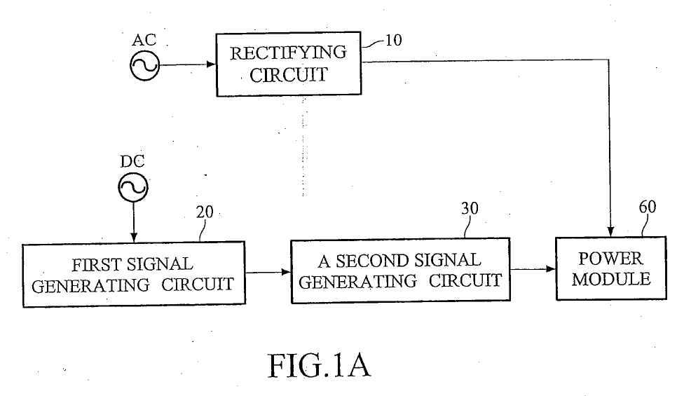

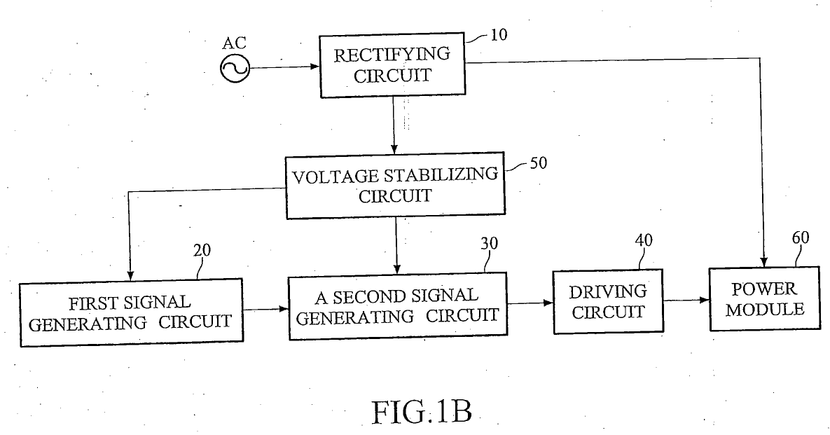

Refer to FIG. 1A showing the block diagram according to the power switch circuit of the invention. The power switch circuit includes a rectifying circuit 10, a first signal generating circuit 20, a second signal generating circuit 30, a power module 60 and a direct current power source DC. The rectifying circuit 10 is connected to an alternating current power source AC and the power module 60. The rectifying circuit 10 rectifies the alternating current power source AC as a direct current power source, which is then delivered to the power module 60. The first signal generating circuit 10 is connected to the direct current power source DC. The second signal generating circuit 20 is connected to the direct current power source DC through the first signal generating circuit 10. The first signal generating circuit 20 outputs a first signal. The second signal generating circuit 30 is connected to the first signal generating circuit 20 and the power module 60. Besides receiving the direct current power source DC, the second signal generating circuit 30 delivers a second signal to the power module 60 after receiving the first signal, outputted from the first signal generating circuit 20. The second signal controls the power module 60 to start or stop operation, such, that the power module 60 is switched into the standby mode or operation mode. When the power module 60 operates formally, the rectifying circuit 10 supplies the direct current power source to the power module 60.

Refer to FIG. 1B showing another block diagram according to the power switch circuit of the invention. The power switch circuit includes a rectifying circuit 10, a first signal generating circuit 20, a second signal generating circuit 30, a driving circuit 40, a voltage stabilizing circuit 50 and a power module 60. The operation and function are given in details as follows.

The rectifying circuit 10 is connected to an alternating current power source AC, a voltage stabilizing circuit 50, and a power module 60. The rectifying circuit 60 rectifies the alternating current power source AC as a direct current power source, which is then delivered to the power module 60 and the voltage stabilizing circuit 50. The first signal generating circuit 20 outputs a first signal. The second signal generating circuit 30 is connected to the first signal generating circuit 20, the voltage stabilizing circuit 50 and the driving circuit 40. Besides receiving the direct current power source from the rectifying circuit 10, the second signal generating circuit 30 outputs a second signal after receiving the first signal from the first signal generating circuit 20. The driving circuit 40 outputs a driving signal to the power module 60 after receiving the second signal. The power module 60 starts or stops operation in response to the driving signal, such, that the system powered by the power module 60 enters to the standby mode or operation mode. When the power module 60 operates normally, the rectifying circuit 10 supplies the direct current power source to the power module 60 for normal operation. Compared with the embodiment in FIG. 1A, the driving circuit 40 and the voltage circuit 50 are additionally provided. The driving circuit 40 operates to output a driving signal to drive the power module 60 in response to the voltage level of the second signal. In case the second signal may drive the power module sufficiently, the driving circuit 40 may be omitted. The voltage stabilizing circuit 50 operates to provide a stable working voltage to the first signal generating circuit 10 and the second signal generating circuit 20. The voltage stabilizing circuit 50 is not necessary in the power switch circuit, and may be employed depending to the requirement.

In one embodiment, the power module 60 is a power supply. In another embodiment, the power module 60 may be a pulse width modulation (PWM) power controller. In another embodiment, the power module 60 may be a power control chip. The power module 60 receives a direct current power source from the rectifying circuit 10 and then delivers the DC power source to the electrical device for normal operation. In the embodiment of FIG. 1B, the first and the second signal generating circuit 20, 30 are connected to the voltage stabilizing circuit 50, for receiving the direct current power source from the rectifying circuit 10.

Through the above mentioned circuitry, the power necessary for normal operation of the system is rectified by the rectifying circuit 10 and then delivered to the system by the power module 60. The electrical device may be forced into the standby mode from the operation mode through the operation given below. First, the first signal generating circuit 20 outputs a first signal. The second signal generating circuit 30 outputs a second signal for controlling the operation of the power module 60 of the electrical device after receiving the first signal. While receiving the second signal, the power module 60 at operation mode stops working and the system enters the standby mode. Because the power module 60 stops operation during the standby mode, the power module 60 does not consume the direct current power source from the rectifying circuit 10. At this moment, only little power, necessary for the operation of the second signal generating circuit 30, is consumed. The electrical device may be forced into the standby mode from the operation mode through the operation given below. The first signal generating circuit 20 outputs a first signal first. The second signal generating circuit 30 outputs a second signal for controlling the operation of the power module 60 of the electrical device after receiving the first signal. The power module 60 enters the operation mode in response to the second signal, while the system also returns back to the operation mode.

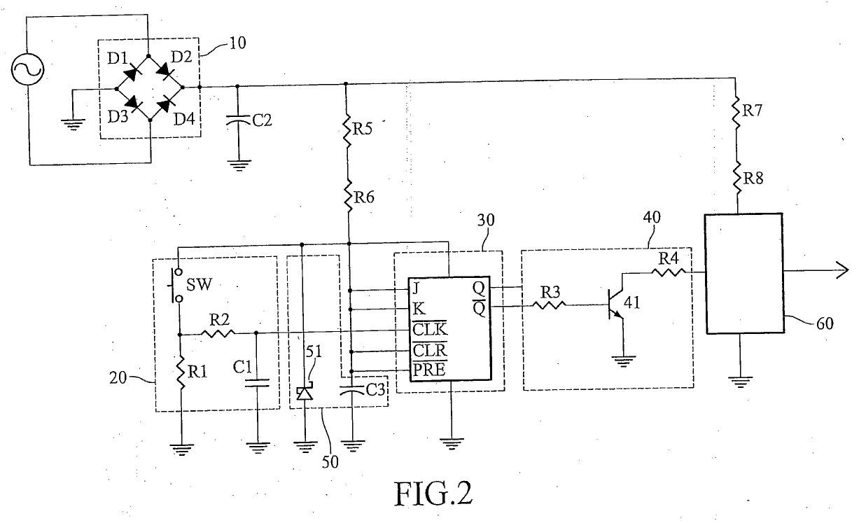

Now refer to FIG. 2 illustrating the detailed circuitry of the first embodiment of the power switch circuit of the invention.

In the first embodiment, the rectifying circuit 10 is a full wave bridge rectifying circuit composed of four diodes D1˜D4, for rectifying the AC power source as DC power source. In another embodiment (not shown), a half wave rectifying circuit may be employed depending on the circuit requirement.

The first signal generating circuit 20 outputs a first signal to the second signal generating circuit 30. The first signal generating circuit 20 at least includes an element capable of generating signals with a variable voltage level, e.g., the switch SW. The exemplary element herein is a toggle switch. One end of the exemplary switch SW is connected to the second signal generating circuit 30, while the other end is connected to the ground through a first resistor R1. In one embodiment, concerning the stability and the detectability the signal generated by the switch SW in the first signal generating circuit 20, an additional second resistor R2 and first capacitor C1 may be added in the circuit, however, both are not necessary. One end of the second resistor R2 is connected to the first resistor R1, while the other end is connected to the second signal generating circuit 30. One end of the first capacitor C1 is connected to the second resistor R2, and the other end is connected to the ground.

The second signal generating circuit 30 receives the direct current power source from the rectifying circuit 10 and the first signal from the first signal generating circuit 20, and then outputs a second signal in response to the first signal. The second signal may be a signal with a high voltage level or low voltage level for controlling the operation of the power module 60. In the embodiment, the second generating circuit 30 is a JK flip-flop. The J terminal and K terminal are connected to the power terminal of the flip flop (one end of the switch SW). The Q output terminal floats and a Q# output terminal are connected to the driving circuit 40. In another embodiment, the Q# output terminal floats, and the Q output terminal are connected to the driving circuit 40. Further, according to the exemplary block diagrams set forth, those who are skilled in the related art may directly connect the Q output terminal or the Q# output terminal to the power module 60 for controlling the operation. This variation depends on the features of the power module 60.

The driving circuit 40 includes a transistor 41, which may be a NPN type BJT. In another embodiment, a PNP type BJT may be used. In yet another embodiment, MOSFET or IGBT may be used. A third resistor R3 is connected between the Q# output terminal and the transistor 41. A fourth resistor R4 is connected at the output terminal (collector) of the transistor 41. One end of the fourth resistor R4 is connected to the power module 60. The emitter of the transistor 41 is connected to the ground.

In one embodiment, a voltage stabilizing circuit 50 may be used to limit the input signal and the output signal of the second signal to a predetermined range, such, that the second signal generating circuit 30 may operate at a stable condition. In the embodiment of FIG. 2, the voltage stabilizing circuit 50 includes a Zener diode 51 and a third capacitor C3. One end of the third capacitor C3 is connected to the second signal generating circuit 30 and the other end is connected to the ground.

In one embodiment, an additional second capacitor C2 may be connected to the output terminal of the rectifying circuit 10 to filter signals, for the stability of the whole circuit. A fifth resistor R5 and a sixth resistor R6, which are connected in series, are connected to the output terminal of the rectifying circuit 10. The other end of the sixth resistor R6 is connected to the capacitor C3. In one embodiment, one single resister may be used instead of the fifth resistor R5 and the sixth resistor R6. A seventh resister R7 and an eighth resistor R8 are connected between the output terminal of the rectifying circuit 10 and the power module 60. In one embodiment, one single resister may be used instead of the seventh resister R7 and eighth resistor R8.

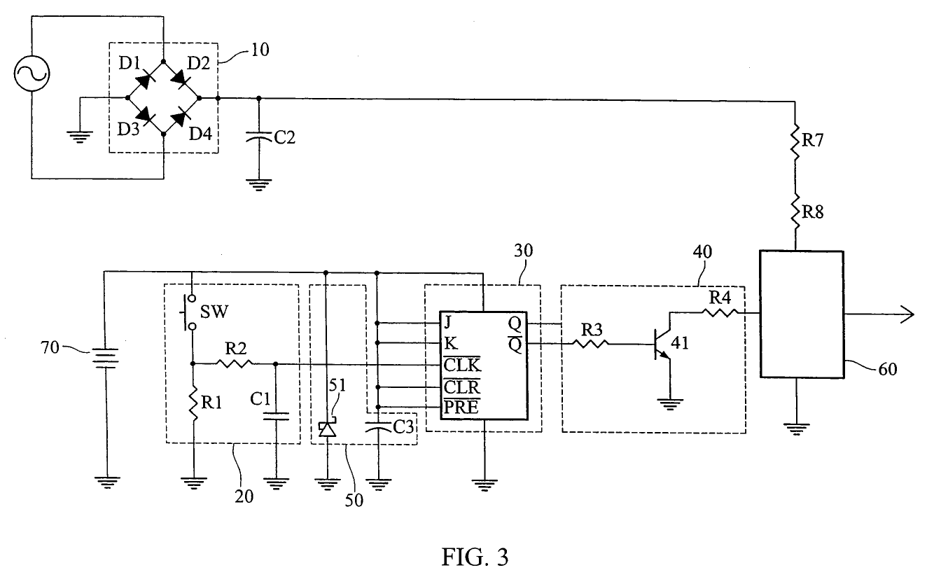

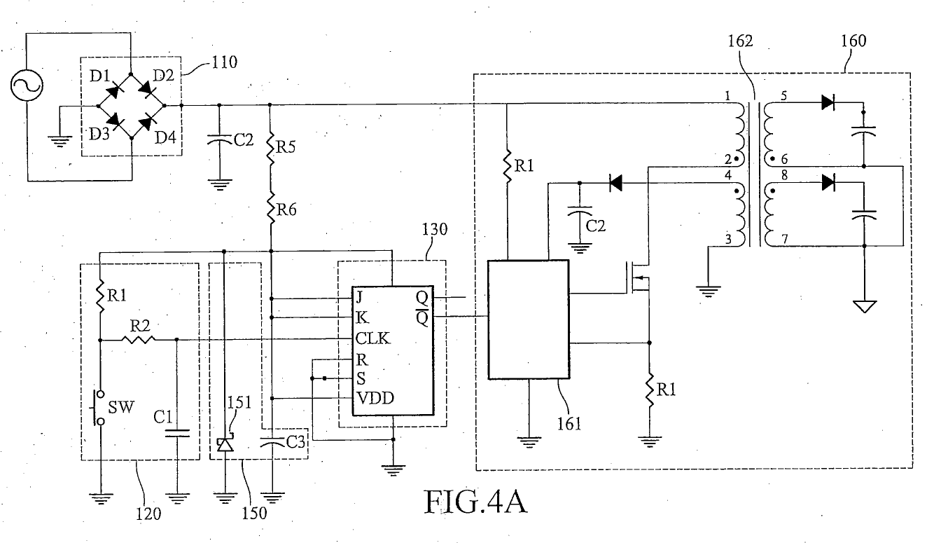

Now refer to FIG. 3 illustrating the detailed circuitry of the second embodiment of the power switch circuit of the invention. In the second embodiment, the functions and operation of the elements, having the same reference number as that in FIG. 2, are the same/similar with those of the first embodiment. Therefore, the description of these elements is abbreviated.

A direct current power source 70 is included in the second embodiment. One end of the DC power source 70 is connected to the switch SW, and the other end is connected to the ground. In this embodiment, the first signal generating circuit 20 and the second signal generating circuit 30 are powered by the direct current power source 70, such as a battery or batteries. The power outputted from the rectifying circuit 10 is supplied to the system, but not supplied to the first signal generating circuit 20 and the second signal generating circuit 30. Therefore, the fifth resistor R5 and the sixth resistor R6 are not necessary. The process for the electrical device, entering to the standby mode from the operation mode, is given below. First, the first signal generating circuit 20 generates a first signal and then delivers the first signal to the second signal generating circuit 30. Then, a second signal for controlling the operation of the power module 60 is issued from the second signal generating circuit 30 in response to the first signal, such, that the power module 60 stops operation. In the meantime, the system enters the standby mode and consumes little, or even does not consume any power output from the rectifying circuit 10. Therefore, the power consumption during the standby mode is greatly reduced. Further, the power, necessary for the operation of the first signal generating circuit 20 and the second signal generating circuit 30, is supplied from the DC power source 70, which is separated from the rectifying current 10. In the first embodiment, the rectifying circuit 10 still supplies little power for the operation of the first signal generating circuit 20 and second signal generating circuit 30, such, that a small power consumption still exits. However, in the second embodiment, the little power necessary for the first signal generating circuit 20 and the second signal generating circuit 30 is reduced, such, that the power consumption during the standby mode decreases more than that of the first embodiment.

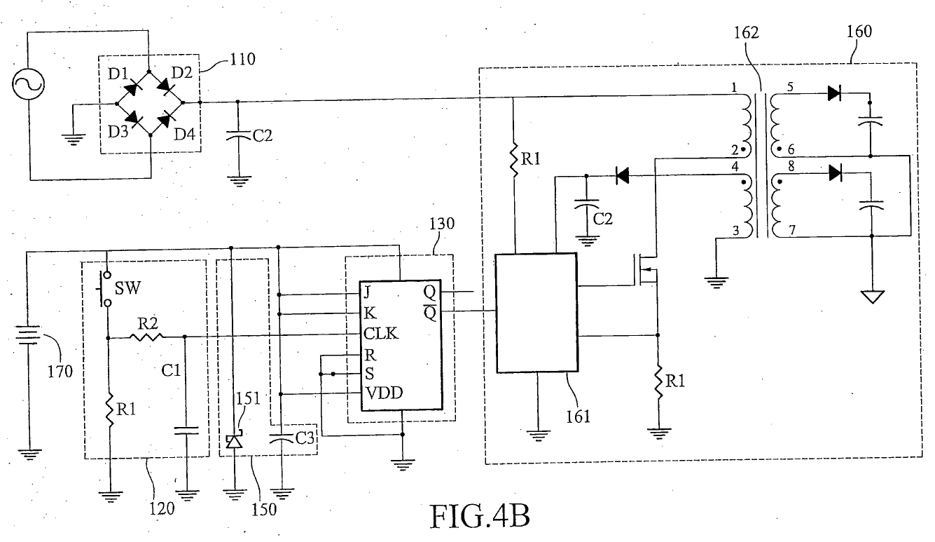

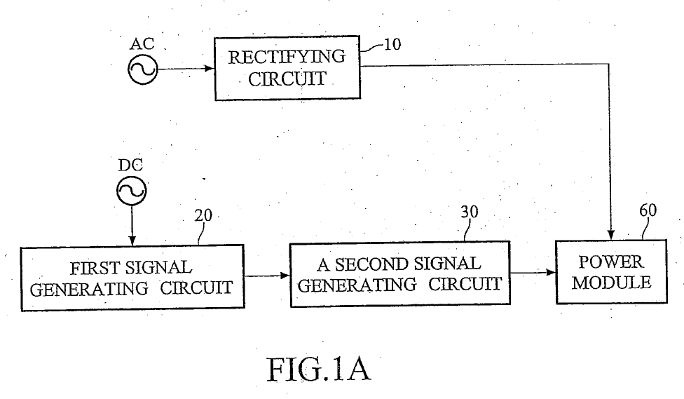

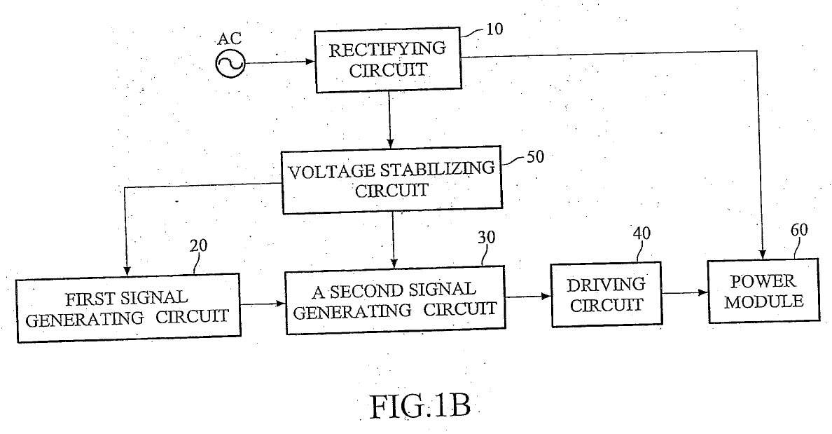

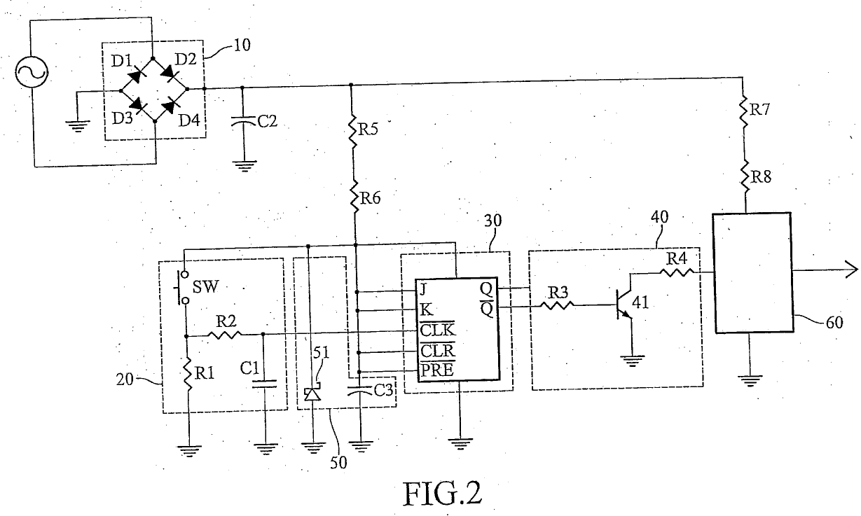

Refer to FIG. 4A, illustrating the embodiment of an electrical device, having the power switch circuit, e.g. LCD monitor, of the invention. It includes a rectifying circuit 110, a signal generating circuit 120, and a control circuit 130. The signal generating circuit 120 includes a switch SW for generating a trigger signal. The control circuit 130 is connected to the signal generating circuit 120 and is powered by the direct current power source DC. A control signal with a high or low voltage level is issued from the control circuit 130 in response to the trigger signal. A power module 160 starts or stops operation in response to the control signal. The power module 160 does not supply power to the display and the microprocessor (not shown) during the standby mode. On the contrary, the power module 160 supplies power to the display and the microprocessor during operation mode. In one embodiment, a voltage stabilizing circuit 150 may be additionally included, to provide a stable working voltage to the control circuit 130.

In this embodiment, the power module 160 at least includes a pulse width modulation (PWM) power controller 161 and a transformer 162. The PWM power controller 161, which is connected to the control circuit 130, receives the control signal. One end of the primary winding is connected to the PWM power controller 161, while the other end is connected to the rectifying circuit 110. Besides the PWM power controller 161 and the transformer 162, the transistors, resistors, and the capacitors necessary for normal operation are also included in the power module 160. The operation of these elements is known to those skilled in the related art and is abbreviated.

FIG. 4B illustrates another embodiment of an electrical device, having the power switch circuit, e.g. LCD monitor, of the invention. The reference numbers of the elements, the same as/ similar to those in FIG. 4A have the same or a similar function and operation, therefore, they are abbreviated.

In this embodiment, the signal generating circuit 120 and the control circuit 130 are powered by the direct current power source 170, e.g. a battery or batteries. The power source outputted from the rectifying circuit 110 is supplied to the system and is not supplied to the signal generating circuit 120 and the control circuit 130.

In the embodiment shown in FIG. 4A and FIG. 4B, a driving circuit 140 may be additionally connected to the control circuit 130. The composition, operation, and function of the driving circuit 140 are the same as those in the embodiments set forth. A driving signal is issued from the driving circuit 140, to drive the power module 160, in response to the voltage level of the control signal. In case the second signal may drive the power module 160 sufficiently, the driving circuit 140 may be abbreviated. The voltage stabilizing circuit 150 operates to provide a stable working voltage to the signal generating circuit 120 and the control circuit 130. The voltage stabilizing circuit 150 is not necessary in the power switch circuit, and may be employed depending on the requirement.

According to the embodiments of the invention, the power switch circuit may be used in a computer, display device, household display, television, recorder and player, set-top box, or audio devices. According to the embodiments, the system IC is not responsible for turning on the device, thus the power module may not provide power during the standby mode and may totally stop, to reduce the power consumption. Through the first and the second signal generating circuit, the power module may be activated again and restart the electrical device. Only power, necessary for operation of the first and the second signal generating circuit, is required, and thus the power consumption during the standby mode is greatly reduced.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power switch circuit for an electrical device having a power module, comprising:
a first signal generating circuit, outputting a first signal; and
a second signal generating circuit, connected to the first signal generating circuit, and outputting a second signal controlling the power module to stop or start operation after receiving the first signal.

2. The power switch circuit as claimed in claim 1 further comprising a voltage stabilizing circuit connected to the first and the second signal generating circuit.

3. The power switch circuit as claimed in claim 2, wherein the voltage stabilizing circuit comprises a Zener diode.

4. The power switch circuit as claimed in claim 1, wherein the second signal is high voltage level or low voltage level.

5. The power switch circuit as claimed in claim 1, wherein the first signal generating is connected to a direct current power source, and the second signal generating circuit is connected to the direct current power source through the first signal generating circuit.

6. The power switch circuit as claimed in claim 5, wherein the direct current power source is a rectified power source or a batter.

7. The power switch circuit as claimed in claim 1, wherein the first signal generating circuit comprises a switch, one end of which connected to the second signal generating circuit.

8. The power switch circuit as claimed in claim 7, wherein the first signal generating circuit further comprises:
a first resistor, one end connected to the switch, and the other end connected to a ground;
a second resistor, one end connected to the switch; and
a capacitor, one end connected to the second resistor, and the other end connected to the ground.

9. The power switch circuit as claimed in claim 1, wherein the second signal generating circuit comprises a flip-flop.

10. The power switch circuit as claimed in claim 1, further comprising a rectifying circuit for receiving an alternating current power source and rectifying the alternating current power source as a direct current power source to supply to the power module.

11. The power switch circuit as claimed in claim 10 further comprises at least one resistor connected between the rectifying circuit and the first signal generating circuit.

12. The power switch circuit as claimed in claim 11, further comprises a capacitor connected between the at least one resistor and a ground.

13. The power switch circuit as claimed in claim 10 further comprises at least one resistor connected between the rectifying circuit and the power module.

14. The power switch circuit as claimed in claim 10, further comprises a capacitor connected the rectifying circuit and the power circuit.

15. The power switch circuit as claimed in claim 1 further comprises a driving circuit connected between the second signal general circuit and the power module, the driving circuit outputting a driving signal for driving the power module after receiving the second signal.

16. The power switch circuit as claimed in claim 15, wherein the driving circuit comprises a transistor and at least one resistor connected to the transistor.

17. A power switch circuit for an electrical device having a power module, comprising:
a direct current power source;
a first signal generating circuit, connected to the direct current power source, and outputting a first signal;
a second signal generating circuit, connected to the first signal generating circuit, and outputting a second signal controlling the power module to stop or start operation after receiving the first signal; and
a driving circuit connected with the second signal general circuit and the power module, the driving circuit outputting a driving signal for driving the power module after receiving the second signal.

18. The power switch circuit as claimed in claim 17 further comprising a voltage stabilizing circuit connected to the first and the second signal generating circuit.

19. The power switch circuit as claimed in claim 18, wherein the voltage stabilizing circuit comprises a Zener diode.

20. The power switch circuit as claimed in claim 17, wherein the first signal generating circuit comprises a switch, one end of which connected to the second signal generating circuit.

21. The power switch circuit as claimed in claim 20, wherein the first signal generating circuit further comprises:
a first resistor, one end connected to the switch, and the other end connected to a ground;
a second resistor, one end connected to the switch; and
a capacitor, one end connected to the second resistor, and the other end connected to the ground.

22. The power switch circuit as claimed in claim 17, wherein the second signal generating circuit comprises a flip-flop.

23. The power switch circuit as claimed in claim 17, wherein the driving circuit comprises a transistor and at least one resistor connected to the transistor.

24. The power switch circuit as claimed in claim 17, further comprising a rectifying circuit for receiving an alternating current power source and rectifying the alternating current power source as a direct current power source to supply to the power module.

25. The power switch circuit as claimed in claim 24 further comprises at least one resistor connected between the rectifying circuit and the first signal generating circuit.

26. The power switch circuit as claimed in claim 25, further comprises a capacitor connected between the at least one resistor and the ground.

27. The power switch circuit as claimed in claim 24 further comprises at least one resistor connected between the rectifying circuit and the power module.

28. The power switch circuit as claimed in claim 24, further comprises a capacitor connected the rectifying circuit and the power circuit.

29. A power switch circuit comprising:
a rectifying circuit;
a signal generating circuit comprising a switch for generating a trigger signal;
a control circuit connected to the signal generating circuit, outputting a control signal of high voltage level or low voltage level after receiving the trigger signal; and
a power module connected to the rectifying circuit and the control circuit, starting or stopping operation in response to the control signal.

30. The power switch circuit as claimed in claim 29, wherein the direct current power necessary for the signal generating circuit and the control circuit is supplied by a battery or the rectifying circuit.

31. The power switch circuit as claimed in claim 29 further comprising a voltage stabilizing circuit connected to the signal generating circuit and the control circuit.

32. The power switch circuit as claimed in claim 31, wherein the voltage stabilizing circuit comprises a Zener diode.

33. The power switch circuit as claimed in claim 29 further comprises a driving circuit connected to the control circuit, the driving circuit outputting a driving signal after receiving the control signal.

34. The power switch circuit as claimed in claim 33, wherein the driving circuit comprises a transistor and at least one resistor connected to the transistor.

35. The power switch circuit as claimed in claim 29, wherein the power module comprising:
a pulse width modulating power controller connected to the control circuit, for receiving the control signal; and
a transformer, one end of the primary winding of the transformer connected to the pulse width modulating power controller, and one end connected to the rectifying circuit.

36. The power switch circuit as claimed in claim 29, wherein the power module is a power supply, a power pulse width modulating (PWM) power controller or a power management chip.

37. A power switch circuit comprising:
a rectifying circuit;
a direct current power source;
a signal generating circuit connected to the direct current power source, and comprising switch for generating a trigger signal;
a control circuit connected to the signal generating circuit, outputting a control signal of high voltage level or low voltage level after receiving the trigger signal; and
a power module connected to the rectifying circuit and the control circuit, starting or stopping operation in response to the control signal.

38. The power switch circuit as claimed in claim 37, wherein the direct current power necessary for the signal generating circuit and the control circuit is supplied by a battery or the rectifying circuit.

39. The power switch circuit as claimed in claim 37 further comprising a voltage stabilizing circuit connected to the signal generating circuit and the control circuit.

40. The power switch circuit as claimed in claim 39, wherein the voltage stabilizing circuit comprises a Zener diode.

41. The power switch circuit as claimed in claim 37 further comprises a driving circuit connected to the control circuit, the driving circuit outputting a driving signal after receiving the control signal.

42. The power switch circuit as claimed in claim 41, wherein the driving circuit comprises a transistor and at least one resistor connected to the transistor.

43. The power switch circuit as claimed in claim 37, wherein the power module comprising:
a pulse width modulating power controller connected to the control circuit, for receiving the control signal; and
a transformer, one end of the primary winding of the transformer connected to the pulse width modulating power controller, and one end connected to the rectifying circuit.

44. The power switch circuit as claimed in claim 37, wherein the power module is a power supply, a power pulse width modulating (PWM) power controller or a power management chip.
